(19) United States
(12) Patent Application Publication
(10) Pub. No.: US 2022/0307447 A1
(43) Pub. Date: Sep. 29, 2022

(54) Charge Air Cooler Bypass Systems and Methods

(71) Applicant: Aurora Flight Sciences Corporation, Manassas, VA (US)

(72) Inventors: Cayce McPheron Boone, Annandale, VA (US); David William Rogers, Jr., Bealeton, VA (US); Bruce Edward Arensen, Reston, VA (US)

(21) Appl. No.: 17/571,735

(22) Filed: Jan. 10, 2022

Related U.S. Application Data
(60) Provisional application No. 63/167,404, filed on Mar. 29, 2021.

(51) Int. Cl. F02K 3/02; B64D 33/08; B64D 27/02; B64D 33/02

(52) U.S. Cl. CPC F02K 3/02; B64D 33/08; B64D 27/02; B64D 33/02; B64D 2033/024; F05D 2220/323

(57) ABSTRACT

A cooling system is disclosed for cooling charge air in a turbocharged diesel internal combustion engine of an aircraft. The cooling system includes a charge air cooler, a charge air bypass valve, and a bypass valve actuator. The charge air cooler is fluidly coupled between the turbocharger assembly and the intake manifold, wherein the charge air cooler is configured to cool the charge air. The charge air bypass valve is moveable between a first position and a second position. The charge air bypass valve is configured to bypass the charge air cooler when in the second position. The bypass valve actuator is configured to move the charge air bypass valve between the first position and the second position.

### RELATED APPLICATION(S)

The present application claims priority to U.S. Provisional Patent Application No. 63/167,404, filed Mar. 29, 2021, and entitled “Charge Air Cooler Bypass Systems and Methods” (Attorney Docket No. 65460US01) which is hereby incorporated by reference in its entirety.

### FIELD

The present disclosure relates to engine systems for aircraft, more specifically, to charge air cooler bypass systems and methods, such as those suitable for use with turbocharged diesel aircraft engine.

### BACKGROUND

Internal combustion engines have been in continuous development and improvement since the nineteenth century and have maintained a dominant position as power plants for various machines and vehicles. In a diesel internal combustion engine, air enters the engine. The engine's cylinders compress the air. Fuel is injected into the compressed air, which ignites the fuel to trigger the motion of the piston and crankshaft to yield a rotary motion. The piston moves back to its original position to expel the spent gas from the engine through the tailpipe as exhaust. This process occurs multiple times every second. Internal combustion engines range in output from a fraction of a horsepower to tens of thousands of horsepower. For example, the simplest internal combustion engine, like those used in some model aircraft, can have a single piston, a single connecting rod, a crankshaft, and a simple jet carburetor contained in a simple cylinder and crankcase structure. Conversely, large aircraft typically employ larger engines with multiple pistons.

Internal combustion engines can be designed to operate with various different fuels, such as gasoline and heavy fuel (whether diesel or jet fuels). Jet fuel is similar to diesel fuel, but differs in terms of hydrocarbons. For example, gasoline consists of hydrocarbons that contain anywhere from 7 to 11 carbon atoms with hydrogen molecules attached, whereas jet fuel contains hydrocarbons more in the range of 12 to 15 carbon atoms. While both gas and diesel engines operate through internal combustion, a diesel engine does not require a spark ignition system because diesel is a self-igniting fuel. Therefore, the ignition process varies for gas and diesel engines differ. More specifically, during the compression process, a spark plug ignites the fuel in a gas engine, whereas diesel engines do not have spark plugs, but simply use high compression to generate the heat required for spontaneous ignition (aka compression ignition).

Employing a diesel engine offers certain advantages over a gas-powered engine. For example, diesel engines offer excellent specific fuel consumption, reduced flammability, and higher density fuel. Further, a diesel engine also allows for consumption of different fuel types and, therefore, can be operated using either diesel fuel or jet fuel. For example, to simplify fuel operations, the Department of Defense (DOD) has adopted a single-fuel concept (SFC) that requires U.S. forces to use only one fuel while deployed. Therefore, a diesel engine allows for increased fuel cross-compatibility.

In some examples, an aircraft may further include a turbocharger, such as a turbocharged diesel aircraft engine. A turbocharged diesel aircraft engine uses a compressor to feed pressurized charge air to the intake manifold. To maximize fuel efficiency, it is beneficial to manage the amount of intake energy of the charge air at the intake manifold to maintain a desired operating condition and/or efficiency. Existing systems and methods, however, do not account for flight-specific conditions and are less efficient for certain vehicles, such as long endurance aircraft.

### SUMMARY

The present disclosure relates to engine systems for aircraft, more specifically, to charge air cooler bypass systems and methods, such as those suitable for use with turbocharged diesel aircraft engine.

According to a first aspect, a method of controlling airflow in a propulsion system to conserve energy in an aircraft comprises: generating, via a compressor, charge air from ambient air; configuring a charge air bypass valve in a first position to urge the charge air to a charge air cooler, cooling the charge air via the charge air cooler; measuring, via one or more sensors, a parameter of the propulsion system; comparing the parameter to a threshold value; and switching, via a bypass valve actuator, the charge air bypass valve from the first position to a second position to bypass the charge air cooler via a bypass charge air pipe when the parameter is less than the threshold value.

In certain aspects, the method further comprises the step of switching, via the bypass valve actuator, the charge air bypass valve from the second position to the first position when the parameter exceeds the threshold value.

In certain aspects, the charge air bypass valve is a two-way valve and the first position is a closed position.

In certain aspects, the second position is an open position.

In certain aspects, the charge air bypass valve is a three-way valve and, when in the first position, the charge air bypass valve fluidly couples the compressor to an intake manifold of an internal combustion engine via the charge air cooler, while prohibiting the charge air from flowing to the intake manifold via the bypass charge air pipe.

In certain aspects, when in the second position, the charge air bypass valve fluidly couples the compressor to the intake manifold via the bypass charge air pipe, while prohibiting the charge air from flowing to the intake manifold via the charge air cooler.

In certain aspects, the method further comprises the step of heating the charge air via a heater when the charge air bypass valve is configured in the second position.

In certain aspects, the heater is positioned at the bypass charge air pipe.

In certain aspects, the one or more sensors includes a temperature sensor and the parameter is a temperature of the charge air.

In certain aspects, the temperature is measured at a point between the charge air cooler and an intake manifold of an internal combustion engine.

In certain aspects, the temperature is measured at a point between the charge air bypass valve and an intake manifold of an internal combustion engine.

In certain aspects, the temperature is measured at a point between the compressor the charge air cooler.

In certain aspects, the temperature is measured at a point between the compressor the charge air bypass valve.

According to a second aspect, a cooling system for cooling charge air from a turbocharger assembly to an intake manifold of an internal combustion engine comprises: a charge air cooler fluidly coupled between the turbocharger assembly and the intake manifold, wherein the charge air cooler is configured to cool the charge air; a charge air bypass valve moveable between a first position and a second position, wherein the charge air bypass valve is configured to bypass the charge air cooler when in the second position; and a bypass valve actuator configured to move the charge air bypass valve between the first position and the second position.

In certain aspects, the cooling system further comprises a first charge air pipe fluidly coupled between the turbocharger assembly and the charge air bypass valve; a second charge air pipe fluidly coupled between the charge air cooler and the intake manifold; and a bypass charge air pipe fluidly coupled between the charge air bypass valve and the intake manifold.

In certain aspects, the cooling system further comprises a heater positioned on the bypass charge air pipe and configured to increase a temperature of the charge air.

In certain aspects, the charge air passes from the turbocharger assembly to the intake manifold via the first charge air pipe, the charge air bypass valve, and the bypass charge air pipe when the charge air bypass valve is configured in the second position.

In certain aspects, the charge air passes from the turbocharger assembly to the intake manifold via the first charge air pipe, the charge air cooler, and the second charge air pipe when the charge air bypass valve is configured in the first position.

In certain aspects, the internal combustion engine is a diesel engine.

In certain aspects, the charge air bypass valve is a two-way valve having a valve inlet fluidly coupled to the turbocharger assembly and a valve outlet fluidly coupled to the intake manifold.

In certain aspects, the charge air bypass valve is a three-way valve having a valve inlet fluidly coupled to the turbocharger assembly, a first valve outlet fluidly coupled to the intake manifold, and a second valve outlet fluidly coupled to the charge air cooler.

In certain aspects, the cooling system further comprises a temperature sensor to measure a temperature of the charge air.

In certain aspects, the temperature sensor is configured to measure the temperature of the charge air at a point between the charge air cooler and the intake manifold.

In certain aspects, the temperature sensor is configured to measure the temperature of the charge air at a point between the charge air bypass valve and the intake manifold.

In certain aspects, the temperature sensor is configured to measure the temperature of the charge air at a point between the turbocharger assembly the charge air cooler.

In certain aspects, the temperature sensor is configured to measure the temperature of the charge air at a point between the turbocharger assembly the charge air bypass valve.

In certain aspects, the bypass valve actuator configured to move the charge air bypass valve between the first position and the second position as a function of the temperature of the charge air.

According to a third aspect, a propulsion system for an aircraft, the propulsion system comprises: an internal combustion engine having an intake manifold; a turbocharger assembly having a compressor mechanically linked with a turbine, wherein the compressor is configured to provide charge air; a charge air cooler fluidly coupled between the compressor and the intake manifold, wherein the charge air cooler is configured to cool the charge air; a charge air bypass valve moveable between a first position and a second position, wherein the charge air bypass valve is configured to bypass the charge air cooler when in the second position; and a bypass valve actuator configured to move the charge air bypass valve between the first position and the second position.

In certain aspects, the propulsion system further comprises: a first charge air pipe fluidly coupled between the turbocharger assembly and the charge air bypass valve; a second charge air pipe fluidly coupled between the charge air cooler and the intake manifold; and a bypass charge air pipe fluidly coupled between the charge air bypass valve and the intake manifold.

In certain aspects, the propulsion system further comprises a heater positioned at the bypass charge air pipe and configured to increase a temperature of the charge air.

In certain aspects, the charge air passes from the turbocharger assembly to the intake manifold via the first charge air pipe, the charge air bypass valve, and the bypass charge air pipe when the charge air bypass valve is configured in the second position.

In certain aspects, the charge air passes from the turbocharger assembly to the intake manifold via the first charge air pipe, the charge air cooler, and the second charge air pipe when the charge air bypass valve is configured in the first position.

In certain aspects, the internal combustion engine is a diesel engine.

In certain aspects, the charge air bypass valve is a two-way valve having a valve inlet fluidly coupled to the turbocharger assembly and a valve outlet fluidly coupled to the intake manifold.

In certain aspects, the charge air bypass valve is a three-way valve having a valve inlet fluidly coupled to the turbocharger assembly, a first valve outlet fluidly coupled to the intake manifold, and a second valve outlet fluidly coupled to the charge air cooler.

In certain aspects, the propulsion system further comprises a temperature sensor to measure a temperature of the charge air.

In certain aspects, the temperature sensor is configured to measure the temperature of the charge air at a point between the charge air cooler and the intake manifold.

In certain aspects, the temperature sensor is configured to measure the temperature of the charge air at a point between the charge air bypass valve and the intake manifold.

In certain aspects, the temperature sensor is configured to measure the temperature of the charge air at a point between the turbocharger assembly the charge air cooler.

In certain aspects, the temperature sensor is configured to measure the temperature of the charge air at a point between the turbocharger assembly the charge air bypass valve.

In certain aspects, the bypass valve actuator configured to move the charge air bypass valve between the first position and the second position as a function of the temperature of the charge air.

In certain aspects, the turbine is driven by exhaust from the internal combustion engine.

### DRAWINGS

The foregoing and other objects, features, and advantages of the devices, systems, and methods described herein will be apparent from the following description of particular embodiments thereof, as illustrated in the accompanying figures; where like reference numbers refer to like structures. The figures are not necessarily to scale, emphasis instead being placed upon illustrating the principles of the devices, systems, and methods described herein.

FIG. 1 illustrates a perspective view of an example aircraft suitable for use with a propulsion system and the cooling system in accordance with one aspect.

FIG. 2a illustrates a block diagram of a first example propulsion system for the example aircraft of FIG. 1.

FIG. 2b illustrates an example air flow diagram of the cooling system of FIG. 2a with the charge air bypass valve in the first position.

FIG. 2c illustrates an example air flow diagram of the cooling system of FIG. 2a with the charge air bypass valve in the second position.

FIG. 3a illustrates a block diagram of a second example propulsion system for the example aircraft of FIG. 1.

FIG. 3b illustrates an example air flow diagram of the cooling system of FIG. 3a with the charge air bypass valve in the first position.

FIG. 3c illustrates an example air flow diagram of the cooling system of FIG. 3a with the charge air bypass valve in the second position.

FIG. 4 illustrates a block diagram of a third example propulsion systems with a heater positioned on the bypass charge air pipe.

FIG. 5 illustrates a flow diagram of an example method of operating a cooling system.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms.

As used herein, the terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. The terms “e.g.,” and “for example” set off lists of one or more non-limiting examples, instances, or illustrations. No language in the specification should be construed as indicating any unclaimed element as essential to the practice of the embodiments.

As used herein, the terms “aerial vehicle” and “aircraft” are used interchangeably and refer to a machine capable of flight, including, but not limited to, both traditional runway and vertical takeoff and landing (“VTOL”) aircraft, and also including both manned and unmanned aerial vehicles (“UAV”). VTOL aircraft may include fixed-wing aircraft (e.g., Harrier jets), rotorcraft (e.g., helicopters, multirotor, etc.), and/or tilt-rotor/tilt-wing aircraft.

As used herein, the term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

As used herein, the terms “circuits” and “circuitry” refer to physical electronic components (i.e., hardware) and any software and/or firmware (“code”), which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code.

As used herein, the term “composite material” as used herein, refers to a material comprising an additive material and a matrix material. For example, a composite material may comprise a fibrous additive material (e.g., fiberglass, glass fiber (“GF”), carbon fiber (“CF”), aramid/para-aramid synthetic fibers, etc.) and a matrix material (e.g., epoxies, polyimides, and alumina, including, without limitation, thermoplastic, polyester resin, polycarbonate thermoplastic, casting resin, polymer resin, acrylic, chemical resin). In certain aspects, the composite material may employ a metal, such as aluminum and titanium, to produce fiber metal laminate (FML) and glass laminate aluminum reinforced epoxy (GLARE). Further, composite materials may include hybrid composite materials, which are achieved via the addition of some complementary materials (e.g., two or more fiber materials) to the basic fiber/epoxy matrix.

As used herein, the terms “communicate” and “communicating” refer to (1) transmitting, or otherwise conveying, data from a source to a destination, and/or (2) delivering data to a communications medium, system, channel, network, device, wire, cable, fiber, circuit, and/or link to be conveyed to a destination.

As used herein, the term “processor” means processing devices, apparatuses, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general purpose microprocessor or microcontroller, a digital signal processing (DSP) processor, an application-specific integrated circuit (ASIC). The processor may be coupled to, or integrated with a memory device. The memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), a computer-readable medium, or the like.

As used herein, circuitry or a device is “operable” of “configured” to perform a function whenever the circuitry or device comprises the necessary hardware and code (if any is necessary) to perform the function, regardless of whether performance of the function is disabled, or not enabled (e.g., by a user-configurable setting, factory trim, etc.).

To prevent overheating, engines typically pass fluid (e.g., air, water, etc.) over or through portions of the engine. For example, an air-cooled engine is regulated by controlling the cooling airflow through the engine via cowl flaps, where as a liquid-cooled engine is regulated by controlling the coolant flow to the primary heat exchanger via a thermostat. Additional cooling airflow regulation may be required to prevent freezing of the coolant in the heat exchanger. Turbocharged engines typically have a charge air cooler (aka, an intercooler or aftercooler) to cool the charge air (i.e., compressed air) exiting the turbocharger compressor to a temperature the engine can safely consume at the intake manifold. Historically, cooling airflow control has not been employed with charge air coolers.

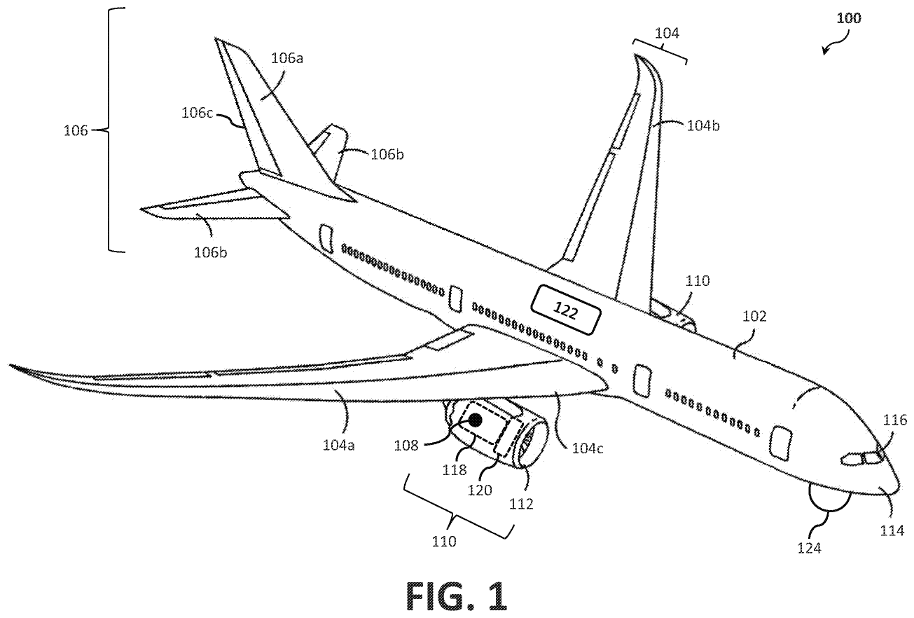

FIG. 1 illustrates a perspective view of an example aircraft 100 suitable for use with the engine system in accordance with one aspect. The aircraft 100 generally comprises an airframe 102 (e.g., a fuselage) having a wing set 104 having a starboard-side wing 104a and a port-side wing 104b. While the wing set 104 is illustrated as back-swept with tapered outboard wing tips, other wing configurations are contemplated, such as non-tapered, rectangular, elliptical, forward-swept, and the like. The airframe 102 further includes an empennage 106 with one or more vertical stabilizers 106a and/or horizontal stabilizers 106b, which may be configured in one of multiple tail configurations. To assist with controlled flight, the aircraft 100 may further comprise one or more moveable control surfaces. For example, each of the wing set 104 and/or vertical stabilizers 106a may include a fixed leading section and a moveable portion pivotally coupled to a trailing edge of the fixed leading section, such as one or more trailing edge flaps, trim tabs, and/or rudder 106c.

The aircraft 100 can be configured to carry passengers and/or cargo. As illustrated, the airframe 102 includes a cockpit/cabin 114 for one or more human operators and/or passengers. The aircraft 100 may be used as, for example, an air taxi, emergency vehicle (e.g., ambulance), pleasure craft, cargo transport, etc. The illustrated cockpit/cabin 114 includes a forward facing transparent aircraft canopy 116 that may be fabricated from, for example, a glass material, and/or an acrylic material. The various structural components of the aircraft 100 may be fabricated from metal, a metal alloy, a composite material, wood, plastic (or other polymer), or a combination thereof. In certain aspects, portions of the aircraft 100 (e.g., the airframe 102 and/or the wing set 104) may be fabricated using one or more additive manufacturing/3D printing techniques, such as fused deposition modeling (FDM), stereolithography (SLA), selective laser sintering (SLS), and/or any other suitable type of additive manufacturing/3D printing.

While the aircraft 100 is generally illustrated as a passenger aircraft having a cockpit for manned operation, the aircraft 100 may also be configured as unmanned (i.e., requiring no onboard pilot) or as both unmanned and fully autonomous (i.e., requiring neither an onboard pilot nor a remote control pilot). For example, the aircraft 100 may be remotely controlled over a wireless communication link by a human operator, computer operator (e.g., remote autopilot), or base station. In an unmanned arrangement, the cockpit/cabin 114 may be omitted. Further, the aircraft 100 can be sized for a particular mission and, therefore, may be substantially smaller (e.g., sized for one, two, or no passengers). In one example, the aircraft 100 is an unmanned and fully autonomous long endurance aircraft used for intelligence, surveillance and reconnaissance (ISR) operation. To that end, the aircraft 100 may include an ISR payload 124 having a suite of sensors to monitor an area (e.g., imaging devices, microphones, thermal sensors, etc.). As can be appreciated, a long endurance aircraft typically stays in the air for extended periods of time to, for example, monitor an area (e.g., via ISR payload 124) and, compared to other aircraft (e.g., those used to transport passengers, cargo, etc.), typically operates at a lower speed to conserve fuel (or power) and to capture data.

The illustrated aircraft 100 includes a plurality of propulsion systems 110 to generate thrust. The plurality of propulsion systems 110 may be positioned on the airframe 102 (e.g., in a tractor configuration or pusher configuration), the wing set 104, the empennage 106, one or more booms, or a combination thereof. Each of the plurality of propulsion systems 110 is oriented to direct thrust aft to facilitate controlled flight. As illustrated, the propulsion systems 110 is coupled (or otherwise integrated) with the aircraft 100, for example, as part of a nacelle pod 112 mounted to the wing set 104 aft of the leading edge 104c. Although the aircraft 100 is illustrated as including two wing-mounted propulsion systems 110 (one on each wing 104a, 104b), the aircraft 100 may include a different number of propulsion systems 110 in other embodiments. The number and locations of the propulsion systems 110 shown in FIG. 1 are merely for example, and can vary as desired. The wing set 104 are used to sustain wing-borne flight for the aircraft 100. As will be appreciated by those of ordinary skill in the art, wing-borne flight refers to the type of flight where lift is provided to an aircraft via one or more airfoils (e.g., wing set 104).

Each of the propulsion systems 110 generally comprises an internal combustion engine 118 coupled to, and configured to drive/rotate, a rotor assembly 120 (e.g., a propeller) about an axis of rotation to generate thrust. During the operation, the propulsion systems 110 are driven (e.g., via the internal combustion engine 118) to generate thrust to propel the aircraft 100 during take-off, cruise, and landing. The rotor assembly 120 generally comprises a plurality of rotor blades 120a radially coupled to a hub 120b. The propulsion systems 110 may spin the rotor assembly 120 via a rotor shaft 206 in a clockwise or a counter-clockwise direction about its axis of rotation, which may be a fixed axis of rotation or a pivoting axis of rotation (e.g., a tilt wing or tilt rotor configuration). In certain aspects, the propulsion system(s) 110 on one side of the airframe 102 may spin in a clockwise direction, while the propulsion systems 110 on the other side of the airframe 102 may spin in a counter-clockwise direction. One of skill in the art would appreciate that the blade pitch of the rotor blades would be adjusted depending on the rotational direction.

The aircraft 100 includes a control system 122 having one or more processors to control supply of fuel/power to, and otherwise control operation of, the aircraft 100 (and its various components). The control system 122 may include or be operably coupled to, inter alia, an engine control unit 108 (which may also be processor-controlled), propulsion systems 110, actuator controllers, a flight controller system, etc. As will be explained below, the control system 122 can be embedded in and/or distributed throughout the aircraft 100. In other words, the control system 122 (or portions thereof) may be embedded into and/or throughout the aircraft 100.

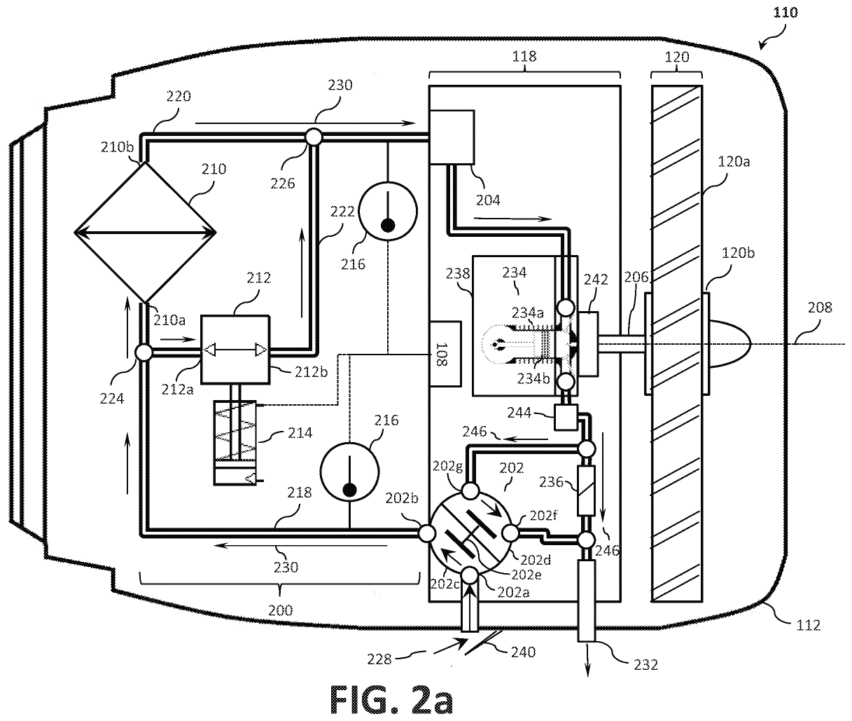

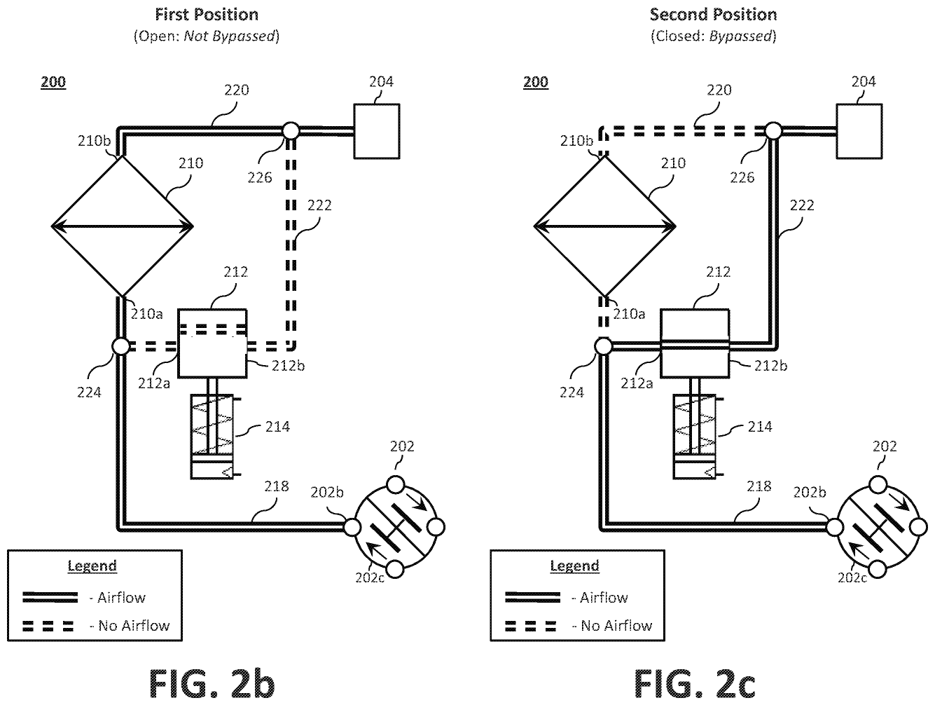

FIG. 2a illustrates a block diagram of an example propulsion system 110 for the example aircraft 100 of FIG. 1. As illustrated, the propulsion systems 110 generally comprises an internal combustion engine 118 coupled to, and configured to drive/rotate, a rotor assembly 120 about its axis of rotation 208 via a rotor shaft 206 (and/or other mechanical gearing/linkage) to generate thrust. The internal combustion engine 118 comprises a turbocharger assembly 202, an intake manifold 204, an exhaust outlet 232, an engine block 238 with one or more piston assemblies 234, a crankshaft 242, and a wastegate 236. In some examples, the internal combustion engine 118 may also be connected to the rotor assembly 120 via a gearbox to change the rotational speed, rotation direction, and/or axis of rotation between the engine and rotor. The gearbox may be located between crankshaft 242 and rotor shaft 206, for example.

Each of the one or more piston assemblies 234 comprises a cylinder 234a and a piston 234b configured to translate within the cylinder 234a. In some examples, the engine block 238 may be cast, machined, or otherwise fabricated to define the one or more cylinders 234a to receive the piston(s) 234b. During operation, each piston 234b translates within its respective cylinder 234a in a reciprocating motion, which is converted to a rotational motion via a crankshaft 242 to drive the rotor shaft 206. In one example, the crankshaft 242 is a shaft driven by a crank mechanism composed of a series of cranks and crankpins to which the connecting rods of an engine are attached. In illustrated example, the internal combustion engine 118 is a turbocharged diesel engine system. In operation, the diesel engine compresses the air in combustion chamber of the cylinders 234a to a pressure (and resultant temperature) that exceeds the auto-ignition temperature of the fuel (e.g., diesel fuel, though a diesel engine is also capable of burning jet fuel). Therefore, when the fuel is injected into the piston assembly 234, the fuel ignites to produce motive power. The combustion chamber pressure and temperature is related directly to the pressure and temperature of the charge air 230 entering at the intake manifold 204 (i.e., the intake energy). Specifically, the lower the intake energy, the lower the resultant combustion chamber temperature. Therefore, the intake energy must be sufficiently high to enable combustion of the fuel. The internal combustion engine 118 expels exhaust 246 from the one or more piston assemblies 234 to the exhaust outlet 232 (e.g., tail pipe) via the turbocharger assembly 202 and/or the wastegate 236.

The turbocharger assembly 202 generally comprises a compressor 202c and a turbine 202d, which are mechanically linked via a drive shaft 202e (or other mechanical linkage). The compressor 202c includes a compressor inlet 202a and a compressor outlet 202b, while the turbine 202d comprises a turbine inlet 202g and a turbine outlet 202f. While illustrated as a single structure, the components of the turbocharger assembly 202 may be provided as separate structures. For example, the compressor 202c and the turbine 202d may be provided in separate housings and linked via the drive shaft 202e (or other mechanical linkage).

The turbine 202d is driven (rotated) by exhaust 246 exiting the internal combustion engine 118. As exhaust 246 exits through an exhaust manifold 244 coupled to the engine block 238, the exhaust 246 passes to the turbine inlet 202g, over the turbine 202d (thereby spinning the turbine 202d), and out the turbine outlet 202f. The drive shaft 202e mechanically links the turbine 202d and the compressor 202c such that the compressor 202c rotates when the turbine 202d rotates.

The compressor 202c is configured to produce and to output, via the compressor outlet 202b, charge air 230 (e.g., pressurized air) using ambient air 228 (e.g., non-pressurized air) received via the compressor inlet 202a. The compressor inlet 202a is positioned outside the aircraft 100. The compressor inlet 202a may be flush with the outside of the nacelle or cowl to receive ambient air 228. In other examples, the compressor inlet 202a may be under and/or aft of a cowl flap 240. More specifically, the compressor 202c is configured to draw in ambient air 228 from outside the airplane via the compressor inlet 202a, compress the ambient air 228 to produce charge air 230, and then transfer the charge air 230 to the compressor outlet 202b. The compressor 202c draws ambient air 228 through an air filter to remove dust and particulate matter. This air filter typically has a bypass mechanism that functions either automatically or manually if the air filter is clogged or otherwise airflow through it is restricted. The charge air 230 ultimately travels from the compressor outlet 202b to the intake manifold 204 of internal combustion engine 118.

In some cases, the turbocharger assembly 202 may generate too much charge air 230, thus increasing the air pressure at the intake manifold 204 beyond an acceptable threshold, which can damage or destroy the engine 118. To manage this pressure, a wastegate 236 may be used that opens and closes to regulate the amount of exhaust 246 that passes over the turbine 202d. The wastegates 236 can be either internal or external to the turbocharger assembly 202. The wastegate 236 prevents the turbine 202d from spinning too fast, thus decreasing the speed of the compressor 202c and the amount of charge air 230. For example, the wastegate 236 is configured to open to bypass the turbine 202d and to direct some or all of the exhaust 246 directly to the exhaust outlet 232.

The charge air 230 exiting the turbocharger assembly 202 may be too hot for the internal combustion engine 118; therefore, a cooling system 200 positioned between the turbocharger assembly 202 and the intake manifold 204 can be used to manage the temperature of the charge air 230. In one example, the cooling system 200 comprises a charge air cooler 210 to cool the charge air 230 after it has passed through a turbocharger assembly 202, but before it enters the intake manifold 204. While the charge air cooler 210 serves to prevent overheating, in some instances, the charge air cooler 210 is not necessary or is undesirable, such as can be the case with a long endurance aircraft 100 operating in cruise mode and/or at a higher altitude.

As an aircraft 100 climbs in altitude, the pressure and temperature of the ambient air 228 decreases. Further, an aircraft 100 designed for long endurance operation often operates at low or reduced power settings during cruise flight. For example, while many aircraft operate at higher speed (thereby operating its engines at a higher capacity), a long endurance aircraft typically travels at a lower speed and higher altitude that do not warrant operating its engines at a higher capacity. The reduced pressure and temperature of the ambient air 228 at higher altitude, combined with the low engine power settings at lower speeds, can result in an airflow feedback loop where the intake energy of the charge air 230 at the intake manifold 204 drops, thus producing exhaust 246 with a lower exhaust energy. That lower exhaust energy, in turn, reduces the speed at which the turbine 202d is driven (rotated), reducing the speed at which the compressor 202c is driven, thus producing a lower pressure and temperature in the charge air 230 at the compressor outlet 202b. This reduced charge air 230 is then cooled by the charge air cooler 210 to produced even lower intake energy than at the start of the airflow feedback loop. This airflow feedback loop continues until there is an insufficient combustion chamber pressure and/or temperature needed to ignite the fuel and one or more piston assemblies 234 ceases operation—resulting in an engine flameout.

As used herein, an “engine flameout” refers to a condition whereby the pressure and temperature of the charge air 230 at the intake manifold 204 drops below an intake energy threshold necessary to achieved auto ignition of the fuel in the piston assembly's 234 combustion chamber. In some examples, only one of a plurality of piston assemblies 234 may cease operation during an engine flameout. If left unaddressed, however, the intake energy will continue to reduce as described above with the airflow feedback loop and the remaining piston assemblies 234 will cease operation until the internal combustion engine 118 stalls completely. To prevent an engine flameout, a safe low power limit can be established for the intake energy of the internal combustion engine 118 (i.e., maintaining it above a given intake energy threshold); however, the intake energy threshold necessary for an unregulated charge air cooler 210 is still above that which is needed for the cruise power setting for long endurance aircraft. As a result, the internal combustion engine 118 will produce more power that is needed to sustain flight, thereby consuming more fuel than needed and reducing the flight time of the aircraft.

To prevent engine flameout while providing the minimum intake energy needed for the aircraft 100 (e.g., a long endurance aircraft) to sustain flight, the charge air cooler 210 can be regulated. In one example, the charge air cooler 210 is controlled (e.g., via engine control unit 108) such that it increases or decreases the amount or degree of cooling. However, a less complex, more durable, and more economical solution is to use a charge air bypass valve 212. For example, the charge air bypass valve 212 can be implemented to bypass the charge air cooler 210 from the cooling system 200 when the charge air cooler 210 is not needed (e.g., once the aircraft 100 is operating in a cruise mode).

In the illustrated example, the cooling system 200 comprises a charge air cooler 210, a charge air bypass valve 212, a bypass valve actuator 214, one or more temperature sensors 216, a first charge air pipe 218, a second charge air pipe 220, and a bypass charge air pipe 222. The charge air cooler 210 is configured to cool the charge air 230 exiting the turbocharger assembly 202 via, for example, a heat exchanger. The one or more temperature sensors 216 are configured to sense a temperature of the charge air 230 at one or more points between the compressor outlet 202b and intake manifold 204 and to provide feedback to a controller (e.g., the engine control unit 108). For example, one or more temperature sensors 216 are positioned at the compressor outlet 202b (but before the cooler inlet 210a of the charge air cooler 210) and/or at the intake manifold 204 (but after the cooler outlet 210b of the charge air cooler 210). Using two temperature sensors 216 may be useful, for example, when determining a temperature drop (ΔT) of the charge air 230 across the charge air cooler 210.

The charge air bypass valve 212 is configured to control the airflow path of the charge air 230 to direct the charge air 230 to the charge air cooler 210, or to redirect (bypass) the charge air 230 around the charge air cooler 210. The bypass valve actuator 214 is configured to selectively control the charge air bypass valve 212 between a first position and a second position via the engine control unit 108 as a function of one or more sensors or commands, such as the one or more temperature sensors 216. The bypass valve actuator 214 may be, for example, a solenoid or motor configured to open and close the charge air bypass valve 212.

The first charge air pipe 218, the second charge air pipe 220, and the bypass charge air pipe 222 are configured to fluidly couple the components of the cooling system 200. As illustrated, for example, the first charge air pipe 218 fluidly couples the compressor outlet 202b of the turbocharger assembly 202 to each of the cooler inlet 210a of the charge air cooler 210 and/or the valve inlet 212a of the charge air bypass valve 212 via a first connection 224 (e.g., a Y-shaped connector or a T-shaped connector). In operation, the first charge air pipe 218 conveys charge air 230 from the turbocharger assembly 202 to the cooler inlet 210a of the charge air cooler 210 and the valve inlet 212a of the charge air bypass valve 212.

The second charge air pipe 220 fluidly couples the cooler outlet 210b of the charge air cooler 210 to the intake manifold 204 via a second connection 226 (e.g., a Y-shaped connector or a T-shaped connector). In operation, the second charge air pipe 220 conveys charge air 230 that has been cooled from the charge air cooler 210 to the intake manifold 204.

The bypass charge air pipe 222 fluidly couples the valve outlet 212b of the air bypass valve 212 to the intake manifold 204 via the second connection 226 (e.g., a Y-shaped connector or a T-shaped connector). In operation, the bypass charge air pipe 222 bypasses the charge air cooler 210 to convey charge air 230 that has not been cooled by the charge air cooler 210 from the air bypass valve 212 to the intake manifold 204.

The charge air bypass valve 212 is therefore configured to alternate between a first position (a not bypassed position) to direct the charge air 230 through the charge air cooler 210 and a second position (a bypassed position) to bypass the charge air 230 around the charge air cooler 210. FIG. 2b illustrates an example air flow diagram of the cooling system 200 of FIG. 2a with the charge air bypass valve 212 in the first position, while FIG. 2c illustrates an example air flow diagram of the cooling system 200 of FIG. 2a with the charge air bypass valve 212 in the second position.

As illustrated in FIG. 2b, the charge air 230 passes from the turbocharger assembly 202 to the intake manifold 204 via the first charge air pipe 218, the charge air cooler 210, and the second charge air pipe 220 when the charge air bypass valve 212 is configured in the first position. As can be appreciated, the charge air 230 does not flow through the charge air bypass valve 212 when it is in the first position (closed position). With reference to FIG. 2c, the charge air 230 passes from the turbocharger assembly 202 to the intake manifold 204 via the first charge air pipe 218, the charge air bypass valve 212, and the bypass charge air pipe 222 when the charge air bypass valve 212 is configured in the second position. As can be appreciated, the charge air 230 does not flow through the charge air cooler 210 when charge air bypass valve 212 is in the second position (open position).

When the charge air bypass valve 212 is closed (the first position), the charge air 230 is urged through the charge air cooler 210 because the charge air 230 cannot pass through the charge air bypass valve 212; however, then when the charge air bypass valve 212 is open, the charge air 230 diverts through the bypass charge air pipe 222 because the flow resistance through the charge air cooler 210 is greater than the flow resistance through the bypass charge air pipe 222.

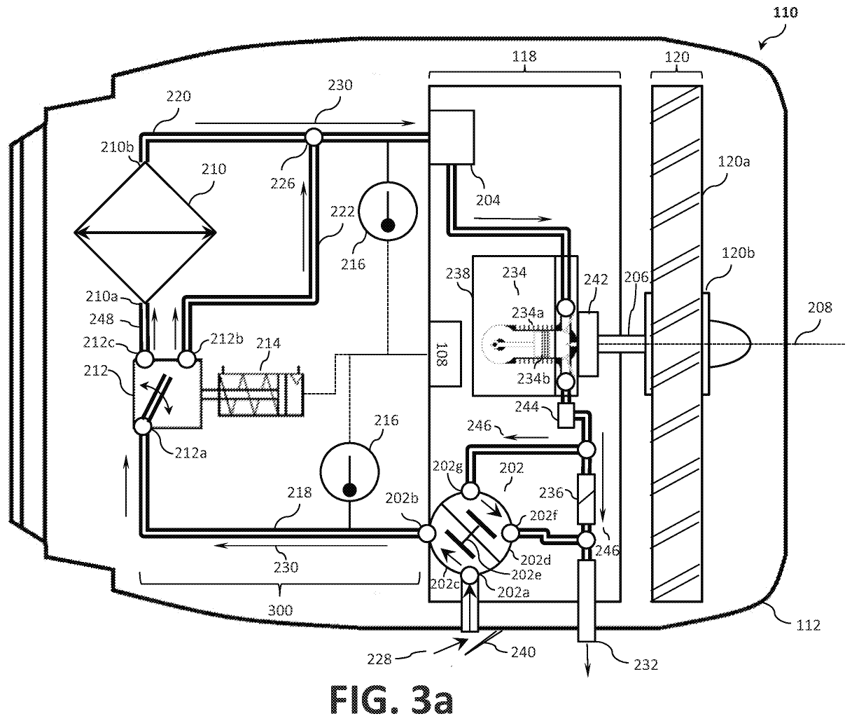

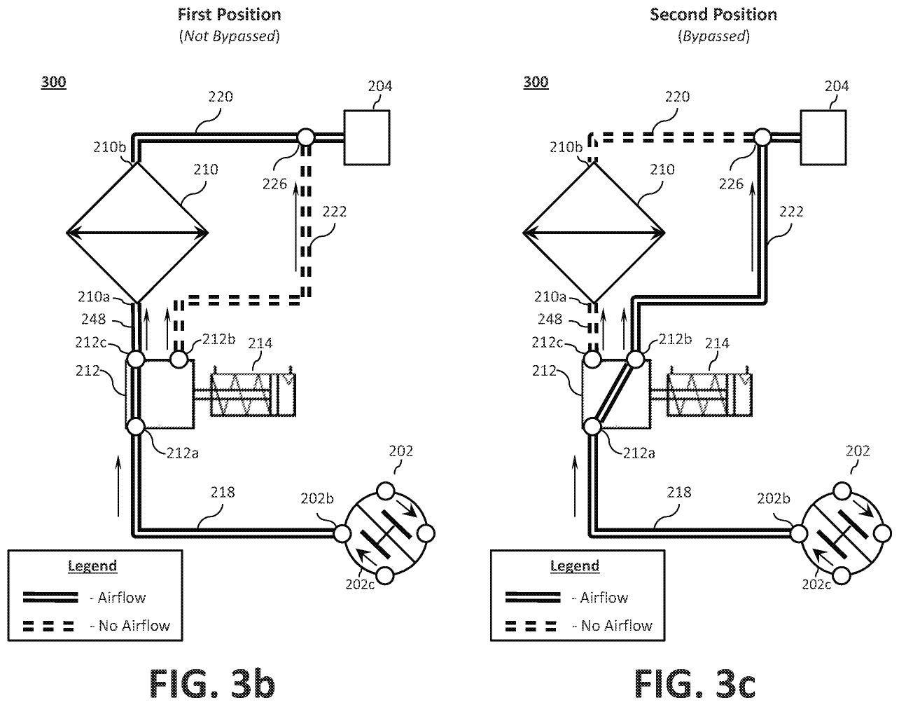

While the charge air bypass valve 212 is described in connection with FIGS. 2a through 2c as a two-way valve that is either “closed” (first positon) or “open” (second position), other types of valves may be employed. For example, the charge air bypass valve 212 may be a three-way valve, an example of which will be described in connection with FIGS. 3a through 3c.

FIG. 3a illustrates a block diagram of an example propulsion system 110 with a cooling system 300 having a three-way charge air bypass valve 212. The cooling system 300 of FIG. 3a is substantially the same as the cooling system 200 of FIG. 2a, except for the charge air bypass valve 212 and associated connections. As illustrated, the charge air bypass valve 212 comprises a valve inlet 212a, a first valve outlet 212b, and a second valve outlet 212c. The valve inlet 212a is fluidly coupled to the compressor outlet 202b via first charge air pipe 218, while the first valve outlet 212b is coupled to the intake manifold 204 via the bypass charge air pipe 222, and the second valve outlet 212c is coupled to the cooler inlet 210a via cooler air pipe 248. As illustrated, the first connection 224 is omitted and the charge air cooler 210 is connected to the second valve outlet 212c of the charge air bypass valve 212 via the cooler air pipe 248. In this example, whereas the cooling system 200 of FIG. 2a relies on flow resistance through the charge air cooler 210 to urge the flow of airflow, the cooling system 300 of FIG. 3a through 3c actively controls the airflow of the charge air 230. In this example, the charge air bypass valve 212 is configured to actively direct the charge air 230 to either the charge air cooler 210 or the bypass charge air pipe 222.

FIG. 3b illustrates an example air flow diagram of the cooling system 300 of FIG. 3a with the charge air bypass valve 212 in the first position. As illustrated, the charge air 230 passes from the turbocharger assembly 202 to the intake manifold 204 via the first charge air pipe 218, the charge air bypass valve 212, the charge air cooler 210, and the second charge air pipe 220 when the charge air bypass valve 212 is configured in the first position. In the first position, the charge air 230 cannot travel to the intake manifold 204 via the bypass charge air pipe 222 because the charge air bypass valve 212 blocks the fluid path to the bypass charge air pipe 222.

FIG. 3c illustrates an example air flow diagram of the cooling system 300 of FIG. 3a with the charge air bypass valve 212 in the second position. As illustrated, the charge air 230 passes from the turbocharger assembly 202 to the intake manifold 204 via the first charge air pipe 218, the charge air bypass valve 212, and the bypass charge air pipe 222 when the charge air bypass valve 212 is configured in the second position. As can be appreciated, the charge air 230 does not flow through the charge air cooler 210 when charge air bypass valve 212 is in the second position. Specifically, in the second position, the charge air 230 cannot travel to the intake manifold 204 via the charge air cooler 210 because the charge air bypass valve 212 blocks the fluid path to the charge air cooler 210.

In some examples, the temperature of the charge air 230 may be too low, even when bypassing the charge air cooler 210. At high altitudes the temperature of the ambient air 228 can be very low when introduced to the airflow loop of the propulsion system 110. For example, the temperature of the ambient air 228 at an altitude of 35,000-80,000 feet above sea level is about −60.0° F. to −70.0° F. To increase the temperature of the charge air 230, a heater 402 can be positioned on the bypass charge air pipe 222 between the charge air bypass valve 212 and the intake manifold 204. The heater may be used in connection with either the two-way charge air bypass valve 212 of FIGS. 2a through 2c or the three-way charge air bypass valve 212 of FIGS. 3a through 3c.

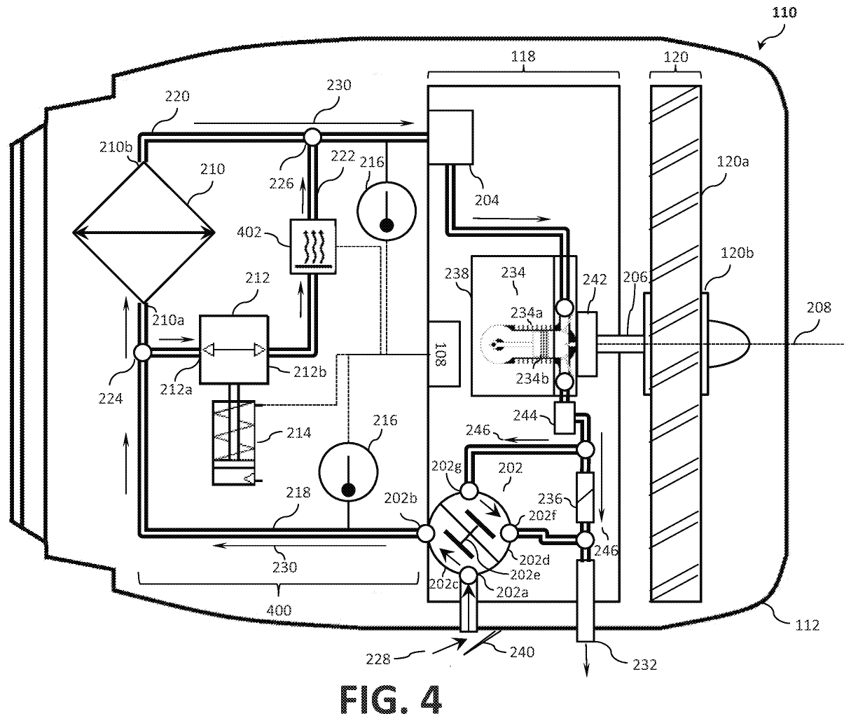

FIG. 4 illustrates a block diagram of an example propulsion system 110 with a heater 402 positioned on the bypass charge air pipe 222 between the charge air bypass valve 212 and the intake manifold 204. The cooling system 400 of FIG. 4 is substantially the same as the cooling system 200 of FIG. 2a, except for the inclusion of a heater 402 and associated connections. The heater 402 is composed of one or more heating elements to increase the temperature of the charge air 230 bypassing the charge air cooler 210. Example heat sources include, for example, electrical, engine coolant, engine oil, engine exhaust, etc. While the heater 402 is illustrated as coupled to the bypass charge air pipe 222, other locations within the cooling system 400 are contemplated, such as at the intake manifold 204. The heater 402 may be controlled (e.g. turned on, turned off, or otherwise adjusted) via the engine control unit 108. As can be appreciated, operating the heater 402 would not be necessary when the charge air 230 is passed through the charge air cooler 210. Therefore, the heater 402 may be controlled as a function of the state of the charge air bypass valve 212. For example, the heater 402 may be deactivated (i.e., off) when the charge air bypass valve 212 is in the first position and activated when the charge air bypass valve 212 is in the second position. In one example, the signal to control the bypass valve actuator 214 may also trigger the heater 402.

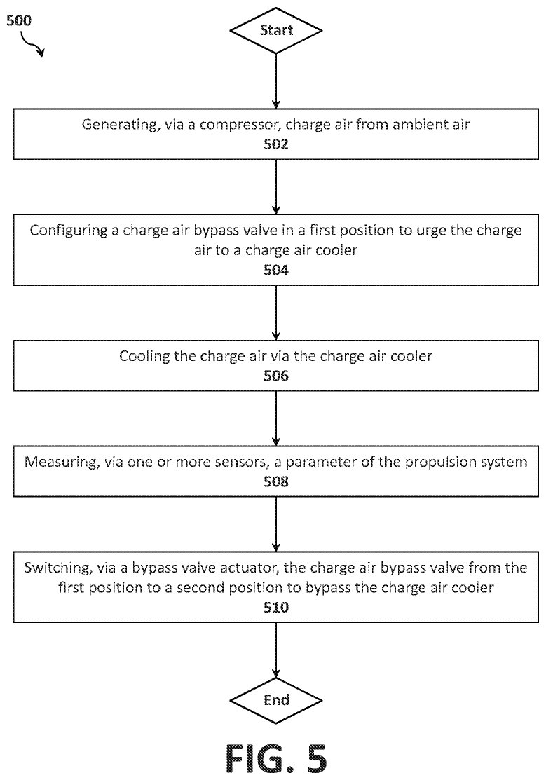

FIG. 5 illustrates an example method 500 for controlling charge air 230 in a cooling system of a propulsion system 110, such as the above-described cooling systems 200, 300, 400. More specifically, a method 500 of controlling airflow of charge air 230 in a propulsion system 110 of an aircraft 100.

At step 502, the compressor 202c generates charge air 230 from ambient air 228;

At step 504, the charge air bypass valve 212 is configured in a first position to urge the charge air 230 to a charge air cooler 210. The charge air bypass valve 212 is fluidly coupled between the compressor 202c and the charge air cooler 210. The charge air bypass valve 212 may be controlled via a bypass valve actuator 214 operable coupled to an engine control unit 108.

At step 506, the charge air cooler 210 cools the charge air 230. The charge air cooler 210 is fluidly coupled between the charge air bypass valve 212 and an intake manifold 204 of an internal combustion engine 118.

At step 508, a parameter of the propulsion system 110 is measured via one or more sensors 216. The parameter of the propulsion system 110 may be measured or monitored in real-time or near-real-time.

At step 510, the charge air bypass valve 212 is switched, via the bypass valve actuator 214, from the first position to a second position to bypass the charge air cooler 210. The charge air bypass valve 212 is fluidly coupled to the intake manifold 204 via a bypass charge air pipe 222. The bypass valve actuator 214 is configured to move the charge air bypass valve 212 between the first position and the second position as a function of the parameter. For example, the one or more sensors 216 may include a temperature sensor 216 and the parameter is a temperature of the charge air 230.

In one example, as described in connection with FIGS. 2a through 2c, the charge air bypass valve 212 is a two-way valve where the first position is a closed position and the second position is an open position. In another example, as described in connection with FIGS. 3a through 3c, the charge air bypass valve 212 is a three-way valve where, when in the first position, the charge air bypass valve 212 fluidly couples the compressor 202c to the intake manifold 204 via the charge air cooler 210, while prohibiting the charge air 230 from flowing to the intake manifold 204 via the bypass charge air pipe 222 and, when in the second position, the charge air bypass valve 212 fluidly couples the compressor 202c to the intake manifold 204 via the bypass charge air pipe 222, while prohibiting the charge air 230 from flowing to the intake manifold 204 via the charge air cooler 210.

Further, the disclosure comprises examples according to the following clauses:

Clause 1. A method 500 of controlling airflow in a propulsion system 110 to conserve energy in an aircraft 100, the method 500 comprising: generating, via a compressor 202c, charge air 230 from ambient air 228; configuring a charge air bypass valve 212 in a first position to urge the charge air 230 to a charge air cooler 210; cooling the charge air 230 via the charge air cooler 210; measuring, via one or more sensors 216, a parameter of the propulsion system 110; comparing the parameter to a threshold value; and switching, via a bypass valve actuator 214, the charge air bypass valve 212 from the first position to a second position to bypass the charge air cooler 210 via a bypass charge air pipe 222 when the parameter is less than the threshold value.

Clause 2. The method 500 of clause 1, further comprising the step of switching, via the bypass valve actuator 214, the charge air bypass valve 212 from the second position to the first position when the parameter exceeds the threshold value.

Clause 3. The method 500 of clauses 1-2, wherein the charge air bypass valve 212 is a two-way valve and the first position is a closed position.

Clause 4. The method 500 of clauses 2-3, wherein the second position is an open position.

Clause 5. The method 500 of clauses 1-2, wherein the charge air bypass valve 212 is a three-way valve and, when in the first position, the charge air bypass valve 212 fluidly couples the compressor 202c to an intake manifold 204 of an internal combustion engine 118 via the charge air cooler 210, while prohibiting the charge air 230 from flowing to the intake manifold 204 via the bypass charge air pipe 222.

Clause 6. The method 500 of clauses 1-5, wherein, when in the second position, the charge air bypass valve 212 fluidly couples the compressor 202c to the intake manifold 204 via the bypass charge air pipe 222, while prohibiting the charge air 230 from flowing to the intake manifold 204 via the charge air cooler 210.

Clause 7. The method 500 of clauses 1-6, further comprising the step of heating the charge air 230 via a heater 204 when the charge air bypass valve 212 is configured in the second position.

Clause 8. The method 500 of clauses 1-7, wherein the heater 204 is positioned at the bypass charge air pipe 222.

Clause 9. The method 500 of clauses 1-8, wherein the one or more sensors 216 includes a temperature sensor 216 and the parameter is a temperature of the charge air 230.

Clause 10. The method 500 of clause 9, wherein the temperature is measured at a point between the charge air cooler 210 and an intake manifold 204 of an internal combustion engine 118.

Clause 11. The method 500 of clause 9, wherein the temperature is measured at a point between the charge air bypass valve 212 and an intake manifold 204 of an internal combustion engine 118.

Clause 12. The method 500 of clause 9, wherein the temperature is measured at a point between the compressor 202c the charge air cooler 210.

Clause 13. The method 500 of clause 9, wherein the temperature is measured at a point between the compressor 202c the charge air bypass valve 212.

Clause 14. A cooling system 200 for cooling charge air 230 from a turbocharger assembly 202 to an intake manifold 204 of an internal combustion engine 118, the cooling system 200 comprising: a charge air cooler 210 fluidly coupled between the turbocharger assembly 202 and the intake manifold 204, wherein the charge air cooler 210 is configured to cool the charge air 230; a charge air bypass valve 212 moveable between a first position and a second position, wherein the charge air bypass valve 212 is configured to bypass the charge air cooler 210 when in the second position; and a bypass valve actuator 214 configured to move the charge air bypass valve 212 between the first position and the second position.

Clause 15. The cooling system 200 of clause 14, further comprising: a first charge air pipe 218 fluidly coupled between the turbocharger assembly 202 and the charge air bypass valve 212; a second charge air pipe 220 fluidly coupled between the charge air cooler 210 and the intake manifold 204; and a bypass charge air pipe 222 fluidly coupled between the charge air bypass valve 212 and the intake manifold 204.

Clause 16. The cooling system 200 of clauses 14-15, further comprising a heater 402 positioned on the bypass charge air pipe 222 and configured to increase a temperature of the charge air 230.

Clause 17. The cooling system 200 of clauses 14-16, wherein the charge air 230 passes from the turbocharger assembly 202 to the intake manifold 204 via the first charge air pipe 218, the charge air bypass valve 212, and the bypass charge air pipe 222 when the charge air bypass valve 212 is configured in the second position.

Clause 18. The cooling system 200 of clauses 14-16, wherein the charge air 230 passes from the turbocharger assembly 202 to the intake manifold 204 via the first charge air pipe 218, the charge air cooler 210, and the second charge air pipe 220 when the charge air bypass valve 212 is configured in the first position.

Clause 19. The cooling system 200 of clauses 14-18, wherein the internal combustion engine 118 is a diesel engine.

Clause 20. The cooling system 200 of clauses 14-19, wherein the charge air bypass valve 212 is a two-way valve having a valve inlet 212a fluidly coupled to the turbocharger assembly 202 and a valve outlet 212b fluidly coupled to the intake manifold 204.

Clause 21. The cooling system 200 of clauses 14-19, wherein the charge air bypass valve 212 is a three-way valve having a valve inlet 212a fluidly coupled to the turbocharger assembly 202, a first valve outlet 212b fluidly coupled to the intake manifold 204, and a second valve outlet 212c fluidly coupled to the charge air cooler 210.

Clause 22. The cooling system 200 of clauses 14-21, further comprising a temperature sensor 216 to measure a temperature of the charge air 230.

Clause 23. The cooling system 200 of clause 22, wherein the temperature sensor 216 is configured to measure the temperature of the charge air 230 at a point between the charge air cooler 210 and the intake manifold 204.

Clause 24. The cooling system 200 of clause 22, wherein the temperature sensor 216 is configured to measure the temperature of the charge air 230 at a point between the charge air bypass valve 212 and the intake manifold 204.

Clause 25. The cooling system 200 of clause 22, wherein the temperature sensor 216 is configured to measure the temperature of the charge air 230 at a point between the turbocharger assembly 202 the charge air cooler 210.

Clause 26. The cooling system 200 of clause 22, wherein the temperature sensor 216 is configured to measure the temperature of the charge air 230 at a point between the turbocharger assembly 202 the charge air bypass valve 212.

Clause 27. The cooling system 200 of clauses 14-26, wherein the bypass valve actuator 214 configured to move the charge air bypass valve 212 between the first position and the second position as a function of the temperature of the charge air 230.

Clause 28. A propulsion system 110 for an aircraft 100, the propulsion system 110 comprising: an internal combustion engine 118 having an intake manifold 204; a turbocharger assembly 202 having a compressor 202c mechanically linked with a turbine 202d, wherein the compressor 202c is configured to provide charge air 230; a charge air cooler 210 fluidly coupled between the compressor 202c and the intake manifold 204, wherein the charge air cooler 210 is configured to cool the charge air 230; a charge air bypass valve 212 moveable between a first position and a second position, wherein the charge air bypass valve 212 is configured to bypass the charge air cooler 210 when in the second position; and a bypass valve actuator 214 configured to move the charge air bypass valve 212 between the first position and the second position.

Clause 29. The propulsion system 110 of clause 28, further comprising: a first charge air pipe 218 fluidly coupled between the turbocharger assembly 202 and the charge air bypass valve 212; a second charge air pipe 220 fluidly coupled between the charge air cooler 210 and the intake manifold 204; and a bypass charge air pipe 222 fluidly coupled between the charge air bypass valve 212 and the intake manifold 204.

Clause 30. The propulsion system 110 of clauses 28-29, further comprising a heater 402 positioned at the bypass charge air pipe 222 and configured to increase a temperature of the charge air 230.

Clause 31. The propulsion system 110 of clauses 28-30, wherein the charge air 230 passes from the turbocharger assembly 202 to the intake manifold 204 via the first charge air pipe 218, the charge air bypass valve 212, and the bypass charge air pipe 222 when the charge air bypass valve 212 is configured in the second position.

Clause 32. The propulsion system 110 of clauses 28-30, wherein the charge air 230 passes from the turbocharger assembly 202 to the intake manifold 204 via the first charge air pipe 218, the charge air cooler 210, and the second charge air pipe 220 when the charge air bypass valve 212 is configured in the first position.

Clause 33. The propulsion system 110 of clauses 28-32, wherein the internal combustion engine 118 is a diesel engine.

Clause 34. The propulsion system 110 of clauses 28-33, wherein the charge air bypass valve 212 is a two-way valve having a valve inlet 212a fluidly coupled to the turbocharger assembly 202 and a valve outlet 212b fluidly coupled to the intake manifold 204.

Clause 35. The propulsion system 110 of clauses 28-34, wherein the charge air bypass valve 212 is a three-way valve having a valve inlet 212a fluidly coupled to the turbocharger assembly 202, a first valve outlet 212b fluidly coupled to the intake manifold 204, and a second valve outlet 212c fluidly coupled to the charge air cooler 210.

Clause 36. The propulsion system 110 of clauses 28-35, further comprising a temperature sensor 216 to measure a temperature of the charge air 230.

Clause 37. The propulsion system 110 of clause 36, wherein the temperature sensor 216 is configured to measure the temperature of the charge air 230 at a point between the charge air cooler 210 and the intake manifold 204.

Clause 38. The propulsion system 110 of clause 36, wherein the temperature sensor 216 is configured to measure the temperature of the charge air 230 at a point between the charge air bypass valve 212 and the intake manifold 204.

Clause 39. The propulsion system 110 of clause 36, wherein the temperature sensor 216 is configured to measure the temperature of the charge air 230 at a point between the turbocharger assembly 202 the charge air cooler 210.

Clause 40. The propulsion system 110 of clause 36, wherein the temperature sensor 216 is configured to measure the temperature of the charge air 230 at a point between the turbocharger assembly 202 the charge air bypass valve 212.

Clause 41. The propulsion system 110 of clauses 28-40, wherein the bypass valve actuator 214 configured to move the charge air bypass valve 212 between the first position and the second position as a function of the temperature of the charge air 230.

Clause 42. The propulsion system 110 of clauses 28-41, wherein the turbine 202d is driven by exhaust 246 from the internal combustion engine 118.

While the various systems and methods are generally described in connection with an aircraft, they may be applied to virtually any industry where a turbocharged engine bypass system is desired. In addition, the order or presentation of method steps is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law. It will be appreciated that the methods and systems described above are set forth by way of example and not of limitation. Numerous variations, additions, omissions, and other modifications will be apparent to one of ordinary skill in the art.

What is claimed is:

1. A method of controlling airflow in a propulsion system to conserve energy in an aircraft, the method comprising:
generating, via a compressor, charge air from ambient air;
configuring a charge air bypass valve in a first position to urge the charge air to a charge air cooler;
cooling the charge air via the charge air cooler;
measuring, via one or more sensors, a parameter of the propulsion system;
comparing the parameter to a threshold value; and
switching, via a bypass valve actuator, the charge air bypass valve from the first position to a second position to bypass the charge air cooler via a bypass charge air pipe when the parameter is less than the threshold value.

2. The method of claim 1, further comprising the step of switching, via the bypass valve actuator, the charge air bypass valve from the second position to the first position when the parameter exceeds the threshold value.

3. The method of claim 1, wherein the charge air bypass valve is a three-way valve and, when in the first position, the charge air bypass valve fluidly couples the compressor to an intake manifold of an internal combustion engine via the charge air cooler, while prohibiting the charge air from flowing to the intake manifold via the bypass charge air pipe.

4. The method of claim 2, wherein, when in the second position, the charge air bypass valve fluidly couples the compressor to an intake manifold via the bypass charge air pipe, while prohibiting the charge air from flowing to the intake manifold via the charge air cooler.

5. The method of claim 1, further comprising the step of heating the charge air via a heater when the charge air bypass valve is configured in the second position.

6. A cooling system for cooling charge air from a turbocharger assembly to an intake manifold of an internal combustion engine, the cooling system comprising:
a charge air cooler fluidly coupled between the turbocharger assembly and the intake manifold, wherein the charge air cooler is configured to cool the charge air;
a charge air bypass valve moveable between a first position and a second position, wherein the charge air bypass valve is configured to bypass the charge air cooler when in the second position; and
a bypass valve actuator configured to move the charge air bypass valve between the first position and the second position.

7. The cooling system of claim 6, further comprising: a first charge air pipe fluidly coupled between the turbocharger assembly and the charge air bypass valve; a second charge air pipe fluidly coupled between the charge air cooler and the intake manifold; and a bypass charge air pipe fluidly coupled between the charge air bypass valve and the intake manifold.

8. The cooling system of claim 7, further comprising a heater positioned on the bypass charge air pipe and configured to increase a temperature of the charge air.

9. The cooling system of claim 7, wherein the charge air passes from the turbocharger assembly to the intake manifold via the first charge air pipe, the charge air bypass valve, and the bypass charge air pipe when the charge air bypass valve is configured in the second position.

10. The cooling system of claim 7, wherein the charge air passes from the turbocharger assembly to the intake manifold via the first charge air pipe, the charge air cooler, and the second charge air pipe when the charge air bypass valve is configured in the first position.

11. The cooling system of claim 6, wherein the charge air bypass valve is a three-way valve having a valve inlet fluidly coupled to the turbocharger assembly, a first valve outlet fluidly coupled to the intake manifold, and a second valve outlet fluidly coupled to the charge air cooler.

12. The cooling system of claim 6, further comprising a temperature sensor configured to measure the temperature of the charge air at a point between the charge air cooler and the intake manifold.

13. The cooling system of claim 12, wherein the temperature sensor is configured to measure the temperature of the charge air at a point between the charge air bypass valve and the intake manifold.

14. The cooling system of claim 12, wherein the temperature sensor is configured to measure the temperature of the charge air at a point between the turbocharger assembly the charge air cooler.

15. The cooling system of claim 12, wherein the temperature sensor is configured to measure the temperature of the charge air at a point between the turbocharger assembly the charge air bypass valve.

16. The cooling system of claim 12, wherein the bypass valve actuator configured to move the charge air bypass valve between the first position and the second position as a function of the temperature of the charge air.

17. A propulsion system for an aircraft, the propulsion system comprising:
an internal combustion engine having an intake manifold;
a turbocharger assembly having a compressor mechanically linked with a turbine, wherein the compressor is configured to provide charge air;
a charge air cooler fluidly coupled between the compressor and the intake manifold, wherein the charge air cooler is configured to cool the charge air;
a charge air bypass valve moveable between a first position and a second position, wherein the charge air bypass valve is configured to bypass the charge air cooler when in the second position; and
a bypass valve actuator configured to move the charge air bypass valve between the first position and the second position.

18. The propulsion system of claim 17, further comprising: a first charge air pipe fluidly coupled between the turbocharger assembly and the charge air bypass valve; a second charge air pipe fluidly coupled between the charge air cooler and the intake manifold; and a bypass charge air pipe fluidly coupled between the charge air bypass valve and the intake manifold.

19. The propulsion system of claim 17, further comprising a temperature sensor configured to measure the temperature of the charge air at a point between the charge air cooler and the intake manifold.

20. The propulsion system of claim 19, wherein the bypass valve actuator configured to move the charge air bypass valve between the first position and the second position as a function of the temperature of the charge air.
